(19) United States
(12) Patent Application Publication
(10) Pub. No.: US 2020/0222912 A1
(43) Pub. Date: Jul. 16, 2020

(54) DEVICE FOR WET MECHANICAL SEPARATION OF A MIXTURE OF SOLID MATERIALS OF DIFFERENT DENSITY

(71) Applicant: Sentrec Holding B.V., Emmen (NL)

(72) Inventor: Hendrik WOLTERS, Emmen (NL)

(21) Appl. No.: 16/248,975

(22) Filed: Jan. 16, 2019

(51) Int. Cl. B03B 5/32

(52) U.S. Cl. CPC B03B 5/32

(57) ABSTRACT

A device for wet mechanical separation of a mixture of solid materials of different density comprises a rotatable drum having a bottom wall, a closed peripheral wall and an open top. The drum tapers conically upwards and vertically. A motor is provided for rotating the drum in a rotation direction. A supply supplies a separating liquid with a mixture of solid materials of different density through the open top into the rotatable drum. During operation rotating the drum results in driving the separating liquid with the mixture of solid materials outwardly towards the inner wall of the drum. Depending on their density solid materials to be separated either float on the surface of separating liquid or sink towards the bottom wall and can be discharged and gathered from the top or bottom of the drum, respectively. The device comprises at least one discharge extending radially outwards from the bottom wall of the drum for separating liquid and solid materials that have sunk to the bottom wall.

### FIELD OF THE INVENTION

The invention relates to a device for wet mechanical separation of a mixture of solid materials of different density, the materials in particular containing plastics, the device comprising a rotatable drum having a bottom wall, a closed peripheral wall and an open top opposite the bottom wall, said drum tapering conically upwards and vertically, a motor for rotating the rotatable drum in a rotation direction, and a supply for supplying a separating liquid, in particular water, with a mixture of solid materials of different density through the open top into the rotatable drum, the device being arranged for during operation rotating the drum so that as a result of centrifugal force the separating liquid with the mixture of solid materials is driven outwardly towards the inner wall of the drum while depending on their density solid materials to be separated either float on the surface of separating liquid or sink towards the bottom wall, and can be discharged and gathered from the top or bottom of the drum, respectively

Such a device for wet mechanical separation of a mixture of solid materials of different density is for example known from DE-C1-19714793. This known device has a conical rotatable drum which is mounted vertically. The drum is rotationally driven by a drive shaft which is designed as a hollow shaft arranged centrically below a bottom wall of the drum. The solid materials to be separated are supplied from above through the open top into the drum as a suspension in the form of a solid material—separating liquid mixture. The supply of the known device is a dispensing channel which extends through a central tube into the drum and terminates slightly below the center of the drum in an expanding funnel. Spaced below the funnel is an acceleration disc which is rotatably mounted by means of fastening struts to the central tube. The acceleration disc has a larger diameter than the funnel. The acceleration disc serves for separation and acceleration of the solid materials and for deflecting the supplied mixture laterally into the drum, which rotates from the outset by entering separating liquid in the drum in the operating state. During operation due to the centrifugal force of the drum, the lighter solid materials to be separated float on the separating liquid forced against the inner wall of the drum and are discharged as floating material through a discharge tube at the top of the drum. In the known device a rinsing disc is provided below the acceleration disc and adjacent the bottom wall of the drum. The rinsing disc is connected via a tube to the acceleration disc and thus rotates therewith. The rinsing disc is provided on its underside with wing-like rotors which form discharge channels located there between. Between the acceleration disc and the rinsing disc a stabilizing disc is fixedly connected to the drum. Heavier solid materials that sink towards the bottom of the drum are deposited on the stabilizing disc which has openings near the peripheral wall of the drum from passing the heavier solid materials to the rinsing disc and consequently through a central discharge opening in the bottom wall of the drum. The central discharge opening in the bottom wall gives access to a central discharge tube which extends through the hollow drive shaft arranged centrically below the bottom wall of the drum. Although the known device efficiently separates lighter from heavier solid materials, the known device requires a large number of components, mostly arranged inside the drum and two motors, one for rotationally driving the drum and the other for rotating the rinsing disc and acceleration disc. Further, it appears that the hollow drive shaft through which the central discharge tube extends needs regular maintenance as does the inner side of the drum. In particular solid materials that have sunk towards the bottom of the wall and are passed via the stabilizing disc and the discharge channels formed by the wing-like rotors under the rinsing disc can negatively influence the rotation of the rinsing disc or block the discharge passages. Thus the known device also requires regular cleaning of the interior of the drum, leading to downtime.

### SUMMARY OF THE INVENTION

It is an object of the invention to provide an alternative device for wet mechanical separation of a mixture of solid materials of different density which device amongst other things needs less components than the known device and which requires less maintenance.

In order to obtain at least one of these objects the invention provides a device for wet mechanical separation of a mixture of solid materials of different density, the materials in particular containing plastics, the device comprising a rotatable drum having a bottom wall, a closed peripheral wall and an open top opposite the bottom wall, said drum tapering conically upwards and vertically, a motor for rotating the rotatable drum in a rotation direction, and a supply for supplying a separating liquid with a mixture of solid materials of different density through the open top into the rotatable drum, the device being arranged for during operation rotating the drum so that as a result of centrifugal force the separating liquid with the mixture of solid materials is driven outwardly towards the inner wall of the drum while depending on their density solid materials to be separated either float on the surface of separating liquid or sink towards the bottom wall, and can be discharged and gathered from the top or bottom of the drum, respectively, characterized in that the bottom wall of the drum comprises at least one discharge extending radially outwards from the bottom wall of the drum for separating liquid and solid materials that have sunk to the bottom wall. By providing the radially outwards extending discharge solid materials that have sunk to the bottom wall and are forced radially outwards by the centrifugal force can be discharged very efficiently from the interior of the drum. It has further appeared that in this manner an acceleration disc and a rinsing disc as required by DE-C1-19714793 are not necessary to obtain a correct separation of solid materials of different density. Further a stabilizing disc and even a central tube surrounding the supply of a separating liquid with a mixture of solid materials of different density can be dispensed with. As a result, the device according to the invention only requires one motor for rotating the drum, which motor need not be a hollow shaft drive motor, since the discharge of heavier solid materials that have sunk to the bottom of the drum are discharge radially and not centrically from the drum.

In an embodiment of a device for wet mechanical separation of a mixture of solid materials of different density according to the invention the at least one radially outwards extending discharge comprises a radially outwards extending hollow arm provided with a discharge outlet, the arm being in fluid communication with the interior of the drum via a discharge aperture. Due to the radially extending arm the centrifugal force is enlarged thereby effectively discharging the heavier solid materials from the interior of the drum and thereby providing a device with a self cleaning drum, as a result of which less maintenance is needed to remove undischarged solid materials from the drum. It has appeared that the discharge of heavier solid materials is further improved when the radially outwards extending arm is curved such that the discharge outlet extends opposite the rotation direction.

In a further embodiment of a device for wet mechanical separation of a mixture of solid materials of different density according to the invention the outlet is provided with a nozzle for regulating the amount of separating liquid discharged in dependence of the solid materials to be separated. By using such a nozzle for regulating the amount of separating liquid discharged from the drum the amount of separating liquid discharged from the drum can be adapted to the amount of separating liquid supplied into the drum, thereby providing a stable continuous operation of the device. In addition to or as an alternative to the provision of nozzles the discharge aperture can be sized for regulating the amount of separating liquid discharged in dependence of the solid materials to be separated.

In a further embodiment of a device for wet mechanical separation of a mixture of solid materials of different density according to the invention the device comprises three radially outwards extending discharges. It has appeared that the device functions optimally with three radially outwards extending discharges.

In a still further embodiment of a device for wet mechanical separation of a mixture of solid materials of different density according to the invention the motor for rotating the rotatable drum in a rotation direction is positioned in a housing below the bottom wall of the drum. The motor can be efficiently shielded from the environment, in particular from the separating liquid, by the housing as a result of which the motor needs less maintenance when compared to the motor for driving the drum according to DE-C1-19714793.

In an embodiment of a device for wet mechanical separation of a mixture of solid materials of different density according to the invention the device comprises a first receptacle arranged below the drum for receiving separating liquid and solid materials that have sunk and solid materials that have sunk towards the bottom wall and are discharged from the drum through the at least one radially outwards extending discharge. In this manner the inventive device can have a relative small foot print.

In a still further embodiment of a device for wet mechanical separation of a mixture of solid materials of different density according to the invention the device comprises a discharge chute extending from the top wall of the drum downwards to a second receptacle separate from the first receptacle, said second receptacle for receiving separating liquid and solid materials that float on the surface of separating liquid and are discharged through the open top out of the drum, said discharge chute at least partly surrounding the drum and being arranged closely adjacent the drum. It has appeared that the discharge tube at the top of the drum of the device known from DE-C1-19714793 can be blocked in particular by plastic foil material. By using the discharge chute the inventive device can efficiently separate plastic foil material floating on the separating liquid without being blocked.

In a still further embodiment of a device for wet mechanical separation of a mixture of solid materials of different density according to the invention the rotatable drum consists of the bottom wall, the closed peripheral wall, the open top opposite the bottom wall, and the at least one radially outwards extending discharge in the bottom wall of the drum, the drum thus being free from internal components. By the inventive device it is for example possible to correctly separate solid materials coming from shredded electricity cables, which solid materials comprise PVC and PE. The PE is the lighter material and during operation of the device floats on the separating liquid while the PVC is heavier and sinks towards the bottom of the drum. The PE separated by the inventive device can then be recycled in an easy manner. Please note that the invention is not restricted to separating PE from PVC and can be used to separate any solid materials of different density by using the correct separating liquid. The inventive device can e.g. also be used to separate oil or coal grit from water.

### BRIEF DESCRIPTION OF THE DRAWINGS

The invention will be further explained with reference to the Figures, in which non-limiting exemplary embodiments of a device for wet mechanical separation of a mixture of solid materials of different density according to the invention are shown:

FIG. 1 schematically shows an embodiment of a device for wet mechanical separation of a mixture of solid materials of different density according to the invention in side view;

FIG. 2 schematically shows part of the embodiment of FIG. 1 in a top view;

FIG. 3 schematically shows the rotatable drum of the device of FIGS. 1 and 2 in perspective; and

FIG. 4 schematically shows another embodiment of a device for wet mechanical separation of a mixture of solid materials of different density according to the invention in perspective.

### DETAILED DESCRIPTION OF EXEMPLARY EMBODIMENTS

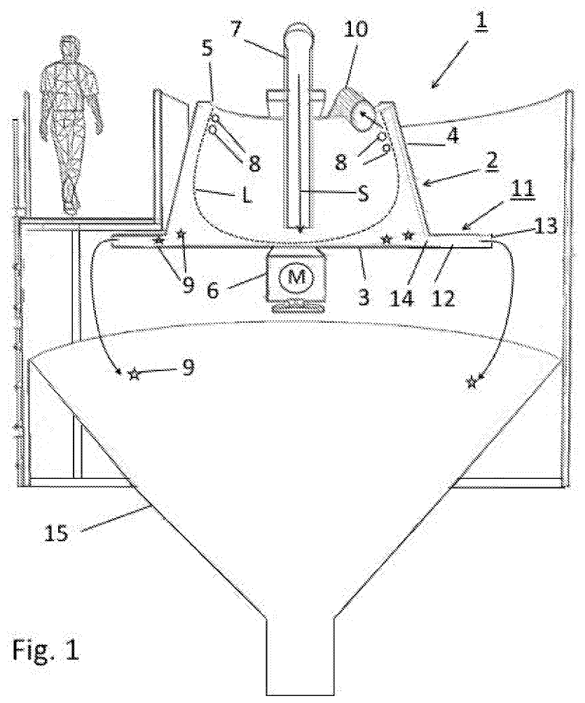

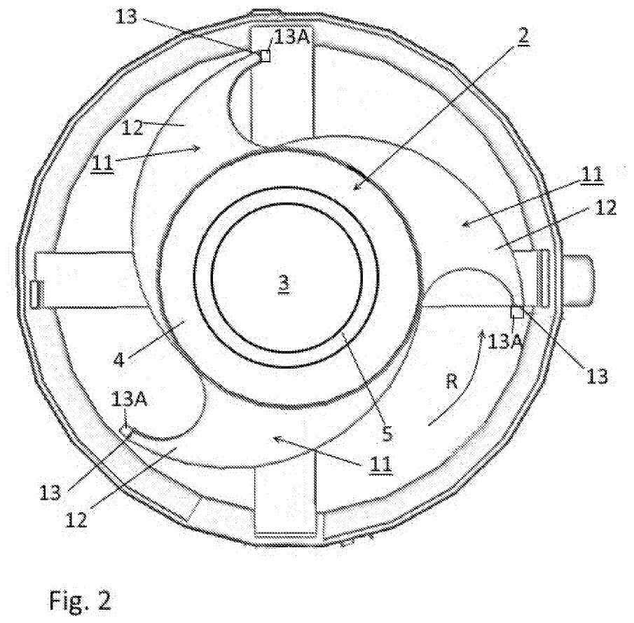

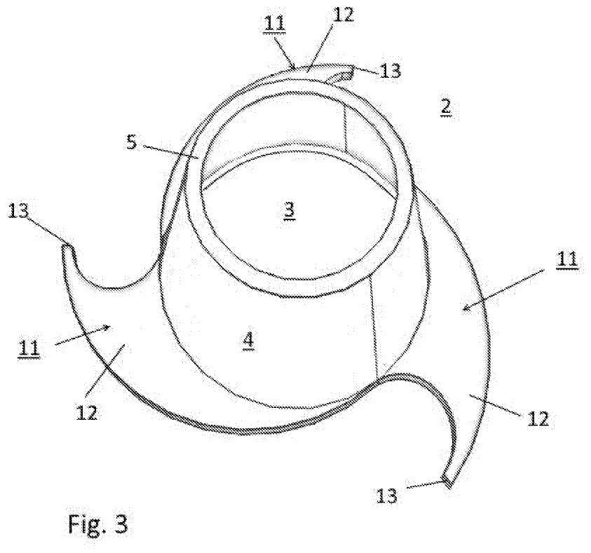

In FIGS. 1 to 3 a first embodiment of a device 1 for wet mechanical separation of a mixture of solid materials of different density is shown in side view. The device comprises a rotatable drum 2 having a bottom wall 3, a closed peripheral wall 4 and an open top 5 opposite the bottom wall. As e.g. shown in FIGS. 1 and 3 the drum 2 tapers conically upwards and vertically. A motor M is provided for rotating the rotatable drum 2 in a rotation direction R (FIG. 2). In the embodiment shown in FIG. 1 the motor M for rotating the rotatable drum 2 is positioned in a housing 6 below the bottom wall 3 of the drum 2. The housing 6 shields the motor M from the environment. Please note however, that the invention is not restricted to the shown embodiment in which the motor is arranged directly below the bottom wall of the drum, and in other embodiments the motor can e.g. be arranged at the side of the drum outside of a first receptacle (as described below) for receiving heavier solid materials and separating liquid the motor driving the rotation of the drum e.g. by means of drive belts.

The device 1 further comprises a supply 7 for supplying a separating liquid, in particular but not restricted to water, with a mixture of solid materials of different density which materials are to be separated. The supply 7 supplies the separating liquid with the mixture through the open top 5 into the rotatable drum 2. As shown in FIG. 1 the supply 7 consists of a supply tube through which the separating liquid and the mixture of solid materials to be separated flow in the direction as indicated by the arrow S.

During operation the drum 2 is rotated so that as a result of centrifugal force the separating liquid with the mixture of solid materials is driven outwardly towards the inner wall of the drum 2, and the separating liquid and the mixture assume a position on the inner wall which is indicated in FIG. 1 by the dotted line L. Depending on the density of the solid materials to be separated, the solid materials either float on the surface of separating liquid L or sink towards the bottom wall 3. In FIG. 1 the lighter solid materials floating on the separating liquid are indicated by ellipses 8, while the heavier solid materials are indicated by stars 9. In the embodiment shown in FIG. 1 the lighter solid materials 8 can be discharged out of the drum 2 from the top 5 by a discharge tube 10 which scoops the lighter solid material 8.

The heavier solid materials 9 sink towards the bottom wall 3 of the drum 2 and as result of the centrifugal force created by the rotating drum 2 are discharged with separating liquid from the drum 2 through discharges 11 which extend radially outwards from the bottom wall 3 of the drum 2. In the embodiment shown the device 1 comprises three radially outwards extending discharges 11, although the invention is not restricted to this number. In alternative embodiments the device can have from one discharge to any number of discharges suitable for the purpose of separating solid materials of different density.

The radially outwards extending discharges 11 each comprise a radially outwards extending hollow arm 12 provided with a discharge outlet 13. Each hollow arm 12 is in fluid communication with the interior of the drum 2 via a discharge aperture 14 (FIG. 1). The radially outwards extending arms 12 are curved such that the discharge outlet 13 extends opposite the rotation direction R as is clearly visible in FIG. 2. The outlet 13 can be provided with a nozzle 13A for regulating the amount of separating liquid discharged in dependence of the solid materials to be separated. Such a nozzle 13A can be a nozzle with an adjustable through flow aperture or can be a replaceable nozzle. In addition or alternatively the discharge aperture 14 can be sized for regulating the amount of separating liquid discharged from the drum 2 in dependence of the solid materials to be separated and in dependence of the amount of separating liquid supplied into the drum 2.

Heavier solid materials 9 discharged from the drum 2 through the radially outwards extending discharges 11 are received in a first receptacle 15 arranged below the drum 2. In order to prevent alien material to fall into the first receptacle 15 it is possible to close the first receptacle 15 by means of a cover with a suitable aperture to receive the drum 2.

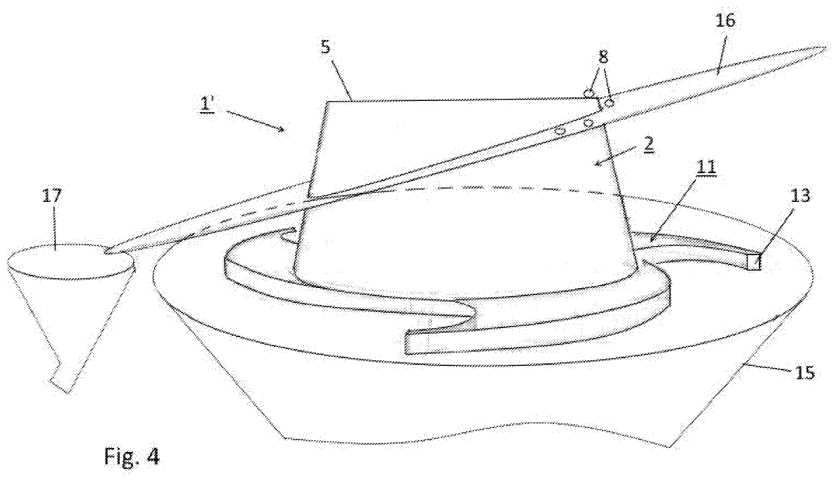

A second embodiment of a device 1′ for wet mechanical separation of a mixture of solid materials of different density is schematically shown in FIG. 4. The second embodiment of the device 1′ differs from the first embodiment of the device 1 in that the discharge tube 10 which scoops the lighter solid material 8 of the first embodiment is replaced by a discharge chute 16 extending from the top 5 of the drum 2 downwards to a second receptacle 17 separate from the first receptacle 15. The second receptacle 17 can thus receive separating liquid and lighter solid materials 8 that float on the surface of separating liquid and are discharged through the open top 5 out of the drum 2. The discharge chute 16 at least partly surrounds the drum 2 and is arranged closely adjacent to the drum 2 and is arranged such that it is prevented that separating liquid can seep between the discharge chute 2 and the peripheral wall of the drum 2 (e.g. by upstanding walls) . Please note that in FIG. 4 the discharge chute 16 is shown schematically and it will be clear that the chute is constructed such that separating liquid and lighter solid materials are only discharged into the second receptacle 17, for example by providing the discharge chute with upstanding walls. Although in FIG. 4 the discharge chute 16 slopes downward in one direction, the invention is not restricted to such an embodiment and in other embodiments the discharge chute can slope down in more than one direction.

As clearly indicated in FIG. 3 the rotatable drum 2 of the inventive device consists of the bottom wall 3, the closed peripheral wall 4, the open top 5 opposite the bottom wall 3 and the three discharges 11 radially outwards extending from the bottom wall 3 of the drum 2, the drum 2 thus is free from internal components.

What is claimed is:

1. A device for wet mechanical separation of a mixture of solid materials of different density, the device comprising:
a rotatable drum having a bottom wall, an inner wall, a closed peripheral wall and an open top opposite the bottom wall, said drum tapering conically upwards and vertically,
a motor for rotating the rotatable drum in a rotation direction, and
a supply for supplying a separating liquid with a mixture of solid materials of different density through the open top into the rotatable drum,
the device being arranged such that, during operation, rotation of the drum provides centrifugal force so that the separating liquid with the mixture of solid materials is driven outwardly towards the inner wall of the rotatable drum, and wherein, depending on their density, the solid materials to be separated either float on the surface of separating liquid or sink towards the bottom wall, and are configured to be discharged and gathered from a top or a bottom of the rotatable drum, respectively,
wherein the device further comprises at least one discharge extending radially outwards from the bottom wall of the rotatable drum for the separating liquid and the solid materials that have sunk to the bottom wall.

2. The device for wet mechanical separation of a mixture of solid materials of different density according to claim 1, wherein the at least one radially outwards extending discharge comprises a radially outwards extending hollow arm provided with a discharge outlet, the arm being in fluid communication with the interior of the drum via a discharge aperture.

3. The device for wet mechanical separation of a mixture of solid materials of different density according to claim 2, wherein the radially outwards extending arm is curved such that the discharge outlet extends opposite the rotation direction.

4. The device for wet mechanical separation of a mixture of solid materials of different density according to claim 2, wherein the outlet is provided with a nozzle for regulating the amount of separating liquid discharged from the drum in dependence of the solid materials to be separated.

5.-10. (canceled)

11. The device for wet mechanical separation of a mixture of solid materials of different density according to claim 3, wherein the outlet is provided with a nozzle for regulating the amount of separating liquid discharged from the drum in dependence of the solid materials to be separated.

12. The device for wet mechanical separation of a mixture of solid materials of different density according to claim 2, wherein the discharge aperture is sized for regulating the amount of separating liquid discharged from the drum in dependence of the solid materials to be separated.

13. The device for wet mechanical separation of a mixture of solid materials of different density according to claim 1, wherein the device comprises three radially outwards extending discharges.

14. The device for wet mechanical separation of a mixture of solid materials of different density according to claim 1, wherein the motor for rotating the rotatable drum in a rotation direction is positioned in a housing below the bottom wall of the drum.

15. The device for wet mechanical separation of a mixture of solid materials of different density according to claim 1, wherein the device comprises a first receptacle arranged below the drum for receiving separating liquid and solid materials that have sunk towards the bottom wall and are discharged from the drum through the at least one radially outwards extending discharge.

16. The device for wet mechanical separation of a mixture of solid materials of different density according to claim 1, wherein the device comprises a discharge chute extending from the top wall of the drum downwards to a second receptacle separate from the first receptacle, said second receptacle for receiving separating liquid and solid materials that float on the surface of separating liquid and are discharged from the open top out of the drum, said discharge chute at least partly surrounding the drum and being arranged closely adjacent the drum.

17. The device for wet mechanical separation of a mixture of solid materials of different density according to claim 1, wherein the rotatable drum consists of the bottom wall, the closed peripheral wall, the open top opposite the bottom wall, and the at least one discharge radially outwards extending from the bottom wall of the drum, the drum being free from internal components.
